(19) United States
(12) Patent Application Publication
(10) Pub. No.: US 2026/0189406 A1
(43) Pub. Date: Jul. 2, 2026

(54) Method, device and system for the certification of a resource

(71) Applicant: ORANGE, ISSY LES MOULINEAUX (FR)

(72) Inventors: Gaël Fromentoux, Chatillon Cedex (FR); Arnaud Braud, Chatillon Cedex (FR); Olivier Le Grand, Chatillon Cedex (FR); Benoit Radier, Chatillon Cedex (FR)

(21) Appl. No.: 18/864,712

(22) PCT Filed: May 5, 2023
(86) PCT No.: PCT/EP2023/061886

§ 371 Date: Nov. 11, 2024

(30) Foreign Application Priority Data
May 12, 2022 (FR) 2204501

(51) Int. Cl. H04L 9/32; H04L 9/08; H04L 9/40

(52) U.S. Cl. CPC H04L 9/3263; H04L 9/0825; H04L 9/3247; H04L 9/40

(57) ABSTRACT

A method, a device and a system for certifying a resource contributing to a communication service that can be instantiated in a data infrastructure. The method is carried out in an evaluation entity deployed in the infrastructure. The evaluation entity is associated with at least one parameter of the resource. The method includes receiving, from the resource, a request to certify the at least one parameter of the resource contributing to the service to be instantiated; comparing the at least one parameter contained in the received request with at least one value required to perform the service in the data infrastructure; and transmitting, to the resource, data certifying the resource in the data infrastructure for the service to be instantiated if the at least one parameter is equivalent to the required value.

### 1. TECHNICAL FIELD

The invention is implemented in a data infrastructure, this infrastructure possibly being instantiated by a plurality of parties involved in the provision of a service to a client. More specifically, the aim of the invention is for a resource of the data infrastructure contributing to the provision of the service to be certified and generated automatically in accordance with a set of requirements specific to the data infrastructure and to the service provided.

### 2. PRIOR ART

Data infrastructures are known and make it possible in particular to be able to provide a service to a client based on the contribution of a plurality of parties pooling resources. The provision of the service requires the parties to make available payload data for the provision of services. Each party decides on the data that it wishes to share and is able to take ownership of these data, in particular so as to avoid said data being misappropriated, reused, deleted or modified without authorization. The data infrastructure is therefore instantiated in the form of a network between the parties, and the parties allow data to be accessed, stored, exchanged and used in accordance with predefined rules specific to the data infrastructure.

The provision of services relating to industrial, tertiary or medical applications or relating to the Internet of Things is therefore relying increasingly on data and resources being made available by separate or varying parties. Data providers, application providers, security entities and communication network operators thus make their own data available in order to develop the service required by a client or that they require themselves.

In order to specify a data exchange framework, some partners have thus initiated an IDSA (International Data Spaces Association) forum, which defines in particular an architecture and mechanisms for exchanging data between separate entities. This architecture, called a data infrastructure or virtual data space here, consists of resources, also called connectors, that make it possible to interconnect the various data spaces maintained by the various parties contributing to the data infrastructure.

The connectors, also called resources, may be relatively varied depending on the service offered, and comprise parameters relating to network links, to information relating to cloud environments, to data types and to software. Thus, when a service is to be instantiated in the data infrastructure, it is necessary to identify the parties contributing to this service along with the resources that each party will share with the other parties in order to be able to effectively implement the service in accordance with the specific needs of the service, for example required by the client receiving the service. Pooling resources assumes that said resources will be guaranteed and certified, and, on the other hand, in the knowledge that the provision of a service requires increasingly short deadlines, in particular for the implementation of services, in particular in response to events (Internet of Things, cyber security), it is necessary to be able to deploy, certify, activate and pool resources within increasingly short deadlines. However, techniques based in particular on certification by a third-party certification authority or the dynamic creation of a data infrastructure by generating resources a priori, independently of the needs of a service, are not suitable for these new needs or these new challenges.

The present invention aims to provide improvements with respect to the prior art.

### 3. SUMMARY OF THE INVENTION

The invention aims to improve the situation by way of a method for certifying a resource contributing to a communication service able to be instantiated in a data infrastructure, the method being implemented in an evaluation entity deployed in the infrastructure, said evaluation entity being associated with at least one parameter of the resource, the method comprising receiving, from the resource, a request to certify the at least one parameter of the resource contributing to the service to be instantiated, comparing the at least one parameter contained in the received request with at least one value required to implement the service in the data infrastructure, transmitting, to the resource, a certification datum certifying the resource in the data infrastructure for the service to be instantiated if the at least one parameter is equivalent to the required value.

The method is novel and inventive since it makes it possible to have a resource, and more particularly a parameter of a resource, certified upstream of a service to be instantiated, the parameter being defined on the basis of the constraints of the service to be instantiated. This method thus allows a party involved in the provision of the service to be able to have the resources that it makes available to the service certified automatically and more quickly than by using a third-party entity, as is the case in the prior art. Since the method is implemented in an evaluation entity deployed in the data infrastructure, it is possible for each party to have parameters of the resource, and therefore the resource, certified with the evaluation entity prior to the implementation of the service, for example as soon as the resource is generated. This certification thus ensures that the resource is compatible with the data infrastructure for implementing the required service. In the knowledge that the parameters of a resource may be highly varied, the method makes provision for an evaluation entity to be associated with one or more parameters of the resource, this meaning that a resource is able to be certified by a plurality of evaluation entities of the infrastructure, depending on the parameters to be certified. The method also enables dynamic certification of the resources since modifying values required for a given service could impact the certification of some resources and therefore the possibility of actually being able to use these resources for a service in the data infrastructure. One and the same resource may also potentially contribute to the provision of multiple separate services, but may ultimately be certified only for some of these services depending on the constraints associated with the services in question. If a new service is to be instantiated, it is possible to use certifications of resources for implementing other services, but only if the values required for this new service correspond to the values of the other services and the certification of the resource is still valid.

According to one aspect of the invention, in the certification method, the certification datum corresponds to the at least one parameter signed by a certificate using a private encryption key of the validation entity or to a private encryption key of the validation entity.

In order to guarantee that the resource involved in the service to be instantiated has been certified in a certain way and validly, the certification datum may advantageously be signed using a private key of the validation entity, guaranteeing a valid certification for all parties involved in the provision of the service and for the client receiving the instantiated service. According to one alternative, the certification datum comprises the private key of the validation entity.

According to another aspect of the invention, in the certification method, the at least one parameter comprises one or more of the following parameters:
a parameter relating to the location of the resource,
a parameter relating to the data processing capacities of the resource,
a parameter relating to the transfer capacities of a link from the resource to the data infrastructure,
a parameter relating to a protocol and/or a protocol version supported by the resource,
a parameter regarding compatibility of the resource with another resource of the infrastructure,
a security parameter supported by the resource,
a parameter relating to a software function of the resource.

The certification method advantageously makes it possible to classify a resource on the basis of a service to be instantiated and therefore to verify that a set of quality of service, security and capacity parameters are indeed supported by the resource potentially made available by a party involved in the data infrastructure. More particularly, this may involve a network link determined by a transfer capacity or even a protocol or a protocol version of the resource. According to another example, this may involve a virtualized network function or a container implemented in a device. This virtualized network function and/or this container is identified generically as a software function.

According to another aspect of the invention, in the certification method, the certification datum furthermore comprises a duration of validity of the certification of the resource.

The certification may advantageously be valid for a duration set by the validation entity, for example in accordance with a requirement originating from an administration entity of the data infrastructure. This duration of validity makes it possible to guarantee that the resource regularly requests a new certification, thus preventing a resource some of whose parameters have been modified from being able to be used for one and the same service or an equivalent service in the data infrastructure.

According to another aspect of the invention, in the certification method, the evaluation entity is at least one entity from among the following entities:
a network slice selection entity of the infrastructure,
a network data analysis entity of the infrastructure,
a function exposure entity of the infrastructure,
a management or control entity of the infrastructure,
an administration entity of the infrastructure.

In the knowledge that the parameters are certified by a function associated with the respective parameters, a resource able to contribute to a service to be instantiated in the infrastructure may advantageously be certified by functions such as the NSSF (Network Slice Selection Function), NWDAF (Network Data Analytics Function), NEF (Network Exposure Function) functions deployed in the data infrastructure and contributing to routing and processing the data of the service. The certification may also advantageously be carried out by a PCF (Policy and Control Function) or BGF (Border Gateway Function) management device or an administration device such as OSS/BSS (Operational/Business Support System), NMS (Network Management System) or EMS (Element Management System) equipment.

The various aspects of the certification method that have just been described may be implemented independently of one another or in combination with one another.

The invention also relates to a method for validating at least one parameter of a resource contributing to a communication service to be instantiated in a data architecture, the method being implemented in the resource, able to communicate with an evaluation entity, the method comprising determining at least one parameter corresponding to a service prescription obtained from a service management entity of the infrastructure, transmitting, to the validation entity, a request to certify the at least one parameter of the resource, receiving, from the evaluation entity, a certification datum certifying the resource in the data infrastructure for the service to be instantiated if the at least one parameter is equivalent to a value required to implement the service in the data infrastructure.

According to one aspect of the invention, the validation method furthermore comprises transmitting, to a resource compliance entity of the infrastructure, a message validating the resource comprising the received certification datum.

The validation method advantageously comprises transmitting a message validating the resource to a resource compliance entity, enabling the latter to be able to validate the contribution of the resource to the service in accordance with availability, quality of service and security criteria required for said service.

According to one aspect of the invention, the validation method furthermore comprises, prior to the transmitting step, obtaining an identifier of the validation entity associated with the at least one parameter to be validated.

According to one aspect of the invention, the validation method furthermore comprises aggregating the certification data received from a plurality of validation entities when at least two validation entities are called upon to validate at least two parameters corresponding to the service prescription.

The validation method is based on the certification of a parameter by a validation entity of the infrastructure associated with this parameter. To validate a resource used to instantiate a service, it is possible to call upon multiple validation entities corresponding to the various parameters. The method may advantageously comprise aggregating the received certification data, corresponding to a resource, for example so as then to inform a compliance entity thereof using a single message.

The various aspects of the certification method that have just been described may be implemented independently of one another or in combination with one another.

The invention also relates to a device for certifying a resource contributing to a communication service able to be instantiated in a data infrastructure, said device being associated with at least one parameter of the resource and implemented in the infrastructure, said device comprising a receiver, able to receive, from the resource, a request to certify the at least one parameter of the resource contributing to the service to be instantiated, a comparator, able to compare the at least one parameter contained in the received request with at least one value required to implement the service in the data infrastructure, a transmitter, able to transmit, to the resource, a certification datum certifying the resource in the data infrastructure for the service to be instantiated if the at least one parameter is equivalent to the required value.

This device is able, in all of its embodiments, to implement the certification method that has just been described.

The invention also relates to a device for validating at least one parameter of a resource contributing to a communication service to be instantiated in a data architecture, said device being able to communicate with an evaluation entity and comprising a determination module, able to determine at least one parameter corresponding to a service prescription obtained from a service management entity of the infrastructure, a transmitter, able to transmit, to the validation entity, a request to certify the at least one parameter of the resource, a receiver, able to receive, from the evaluation entity, a certification datum certifying the resource in the data infrastructure for the service to be instantiated if the at least one parameter is equivalent to a value required to implement the service in the data infrastructure.

This validation device is able, in all of its embodiments, to implement the validation method that has been described above.

The invention also relates to a system for certifying a resource contributing to a communication service able to be instantiated in a data infrastructure, said system comprising:
a certification device as described above,
a validation device as also described above.

The invention furthermore aims to improve the situation by way of a method for dynamically developing a data infrastructure in a communication network, said infrastructure comprising a set of resources made available by a plurality of entities, said method being implemented in a service management device able to determine a set of resources for implementing a data service, and comprising
obtaining a request to instantiate said service, said request comprising a parameter relating to a user of the service and a parameter relating to the geographical area in which said service is to be instantiated,
determining an entity of the plurality, able to contribute to the implementation of said service, on the basis of the parameters obtained in the instantiation request,
sending, to a resource orchestration device of said determined entity, a first request to deploy a resource in the data infrastructure, said first request comprising the obtained parameters and a criterion regarding compliance of the resource with the data infrastructure,
receiving, from the orchestration device of said entity of the plurality, an agreement message comprising an identification of the resource to be deployed in the data infrastructure.

The method for dynamically developing a data infrastructure, also called a virtual data space, is novel and inventive since it makes it possible to be able to deploy or update, dynamically, a multi-party architecture with a view to deploying a service in accordance with a set of rules specific to the virtual data space. The dynamic development method corresponds to creating, modifying or changing the configuration of a data infrastructure. Entities contributing to this space by making resources available are thus able to add resources dynamically to the space depending on the services that the space should support. A service provider may thus communicate a certain number of criteria of the service to a service management device of the virtual data space, and the latter may translate these criteria into resources and request these resources from one or more entities. The method thus makes it possible, on the one hand, to deploy only the resources required for the services actually required, thus avoiding excessive consumption of resources within the data space, and, on the other hand, to ensure that the services actually used to provide the service are dynamically compatible with specifications comprising criteria regarding compliance of the virtual data space, in line with the required service. Using this method, it is possible for example for the resources to comply with routing and security conditions specific to the data space and quality of service parameters specific to the service to be deployed. Thus, a priori and not only a posteriori, as is most often the case in techniques from the prior art, a client or a user will be able to obtain a guarantee that constraints or criteria are complied with, while at the same time limiting the number and type of resources activated for the service.

According to one aspect of the invention, in the dynamic development method, the parameter relating to a user comprises a parameter indicating that the user consents to the data associated with them being analyzed and/or collected.

In a context where an increasing amount of user data is processed and analyzed, the method advantageously makes it possible to be able to indicate whether or not a user authorizes the collection and/or analysis of data concerning them, the consent parameter being able to correspond for example to a license to use the data, according to one alternative for a given period.

According to one aspect of the invention, in the dynamic development method, the first deployment request furthermore comprises a deadline to be complied with for the deployment of said resource.

The method aims to make it possible to deploy and therefore use resources only on the basis of the services required; it is also advantageous to be able to ensure that the resource requested for a given service is actually available at the time when the service is activated or used. The management device may therefore advantageously add, to its request, a deadline to be complied with by the entity called upon to make the resource available.

According to one aspect of the invention, in the dynamic development method, the first deployment request furthermore comprises an address of an evaluation entity able to certify said resource.

Certifying a resource has the advantage of being able to guarantee that said resource corresponds to constraints relating to a given service. Moreover, certification by a third-party entity is generally a lengthy process and does not correspond to the dynamism required for the dynamic development method. The information about an evaluation entity makes it possible to reconcile speed of certification with the benefit that a resource that is made available is indeed certified.

According to one aspect of the invention, in the dynamic development method, the agreement message furthermore comprises a certification datum certifying the resource in the data infrastructure associated with the service to be implemented.

Advantageously, the agreement message received from the orchestration device comprises a certification datum, such as for example a private key and/or a certificate associated with the validation entity that certified the resource made available by the entity. This validation datum provides a guarantee to the resource management entity, but also possibly to the client, that the service is indeed implemented by resources the operation or content of which are indeed guaranteed by a validation entity.

According to one aspect of the invention, in the dynamic development method, the resource comprises at least one of the following elements:
a datum used to implement the service,
a routing capacity,
a capacity to process or isolate a datum relating to the service,
a protocol or a protocol version used to transport data relating to the service,
an identifier of a data center,
a software function able to process a datum of the service,
a data processing capacity of the resource,
an identifier or a description of a software function, such as a container and/or a virtualized network function implemented in the resource.

A resource, according to the method, may correspond to any type of element involved in a service. It may thus be a datum, for example for enriching a service or corresponding to a content item required for the service. It may also be a routing capacity such as a network link for routing the data of the service. It may be an identifier of a data center, for example of a cloud data center, for storing data. It may also be a software function for example for processing the data of the service (optimization, enrichment, filtering, etc.).

It may be a protocol or a protocol version used to route transfer data and/or control data relating to the service or else an overall processing capacity of the resource.

It may also be a combination of these elements.

According to one aspect of the invention, the dynamic development method comprises, as an alternative to receiving an agreement message, receiving a disagreement message, said message comprising a datum indicating a reason relating to the parameters and/or to the compliance criterion included in the deployment request.

Instead of the agreement message, the entity that is called upon may transmit a disagreement or denial message to the service management device, comprising a cause indicating why the orchestration device is not able to offer a resource, this cause more specifically being linked to the compliance criterion linked to the virtual data space and/or to the parameters required for the service. This information may thus be taken into account so that the management device modifies the request, for example in agreement with the client, or else revokes the entity, or else calls upon another entity. According to one aspect of the invention, the dynamic development method furthermore comprises transmitting, to the orchestration device of the entity of the plurality, a second request to deploy a resource in the event of failure of the first request, said request comprising the obtained parameters and a criterion regarding compliance with the data infrastructure,
incrementing a counter counting the number of deployment requests transmitted to the orchestration device.

According to one aspect of the invention, the dynamic development method furthermore comprises, in the event of no response from the orchestration device initially called upon or if the counter has reached a maximum value,
transmitting, to an orchestration device of another entity of the plurality, a new request to deploy a resource, said request comprising the obtained parameters and a criterion regarding compliance with the data infrastructure,
updating a resource register in the event of receiving, from the orchestration device of the other entity, an agreement message comprising an identification of the resource deployed in the data infrastructure.

In order to satisfy the need to deploy the required service, the service management device may advantageously call upon another orchestration device to make available a resource required for the service in accordance with the required compliance and quality criteria. This provision makes it possible to improve the availability of a service following a number of failed requests to a first entity or else in the event of no response from a first called-upon entity. Registration in a resource register makes it possible to be able to call upon this orchestrator directly in the event of a resource being needed for an equivalent service.

The various aspects of the dynamic development method that have just been described may be implemented independently of one another or in combination with one another. The invention also relates to a method for making available a resource in a data infrastructure of a communication network for instantiating a service, said infrastructure comprising a set of resources made available by a plurality of entities, said method being implemented in a resource orchestration device able to determine the compatibility of the resource with the data infrastructure, and comprising:
receiving, from a service management device, a request to deploy a resource in the data infrastructure, said request comprising a parameter relating to the user of the service and a parameter relating to the geographical area in which said service is to be deployed and furthermore comprising a criterion regarding compliance of the resource with the data infrastructure,
determining the resource on the basis of the received parameters and compliance criterion and values relating to the service and to the data infrastructure,
transmitting, to the service management device, an agreement message comprising an identification of the determined resource to be deployed in the data infrastructure.

The invention also relates to a device for dynamically developing a data infrastructure in a communication network, said infrastructure comprising a set of resources made available by a plurality of entities, said device being able to determine a set of resources for implementing a data service, and comprising:
an obtaining module, able to obtain a request to instantiate said service, said request comprising a parameter relating to a user of the service and a parameter relating to the geographical area in which said service is to be instantiated,
a determination module, able to determine an entity of the plurality, able to contribute to the implementation of said service, on the basis of the parameters obtained in the instantiation request,
a transmitter, able to send, to a resource orchestration device of said determined entity, a first request to deploy a resource in the data infrastructure, said first request comprising the obtained parameters and a criterion regarding compliance of the resource with the data infrastructure,
a receiver, able to receive, from the orchestration device of said entity of the plurality, an agreement message comprising an identification of the resource to be deployed in the data infrastructure.

This dynamic development device is able, in all of its embodiments, to implement the dynamic development method that has just been described.

The invention also relates to a device for making available a resource in a data infrastructure of a communication network for instantiating a service, said infrastructure comprising a set of resources made available by a plurality of entities, said device being able to determine the compatibility of the resource with the data infrastructure, and comprising:
a receiver, able to receive, from a service management device, a request to deploy a resource in the data infrastructure, said request comprising a parameter relating to the user of the service and a parameter relating to the geographical area in which said service is to be deployed and furthermore comprising a criterion regarding compliance of the resource with the data infrastructure,
a determination module, able to determine the resource on the basis of the received parameters and compliance criterion and values relating to the service and to the data infrastructure,
a transmitter, able to transmit, to the service management device, an agreement message comprising an identification of the determined resource to be deployed in the data infrastructure.

The invention also relates to computer programs comprising instructions for implementing the steps of the respective certification, validation, dynamic development and availability-making methods that have just been described when these programs are each executed by a processor, and to a recording medium able to be read, respectively, by a certification device, a validation device, a dynamic development device and an availability-making device on which the computer programs are recorded.

The abovementioned programs may use any programming language, and be in the form of source code, object code or intermediate code between source code and object code, such as in a partially compiled form, or in any other desirable form.

The abovementioned information media may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc.

Moreover, an information medium may be a transmissible medium such as an electrical or optical signal, which may be routed via an electrical or optical cable, by radio or by other means. A program according to the invention may in particular be downloaded from a network such as the Internet.

Alternatively, an information medium may be an integrated circuit in which a program is incorporated, the circuit being designed to execute or to be used in the execution of the methods in question.

### 4. BRIEF DESCRIPTION OF THE DRAWINGS

Other features and advantages of the invention will become more clearly apparent on reading the following description of particular embodiments, which are provided by way of simple illustrative and non-limiting examples, and the appended drawings, in which:

FIG. 1 shows a data infrastructure of data made available by a set of parties according to one aspect of the invention.

FIG. 2 shows a method for certifying a resource in a data infrastructure according to one embodiment of the invention.

FIG. 3 shows a method for dynamically developing a data infrastructure, according to another embodiment of the invention.

FIG. 4 shows a method for dynamically developing a data infrastructure, according to another embodiment of the invention.

FIG. 5 shows a method for certifying a resource contributing to a communication service able to be instantiated in a data infrastructure according to another embodiment.

FIG. 6 shows a device for certifying a resource contributing to a communication service able to be instantiated in a data infrastructure according to another embodiment.

FIG. 7 shows a device for validating at least one parameter of a resource contributing to a communication service to be instantiated in a data architecture according to another embodiment.

FIG. 8 shows a device for dynamically developing a data infrastructure in a communication network according to another embodiment.

FIG. 9 shows a device for making available a resource in a data infrastructure of a communication network for instantiating a service according to another embodiment.

### 5. DESCRIPTION OF THE EMBODIMENTS

In the remainder of the description, a presentation is given of embodiments of the invention in a communication network. This network may be implemented in order to route communication data to fixed or mobile terminals, and the network may be implemented using physical equipments and/or virtualized functions. This network may be used to route and/or process home customer or business customer data.

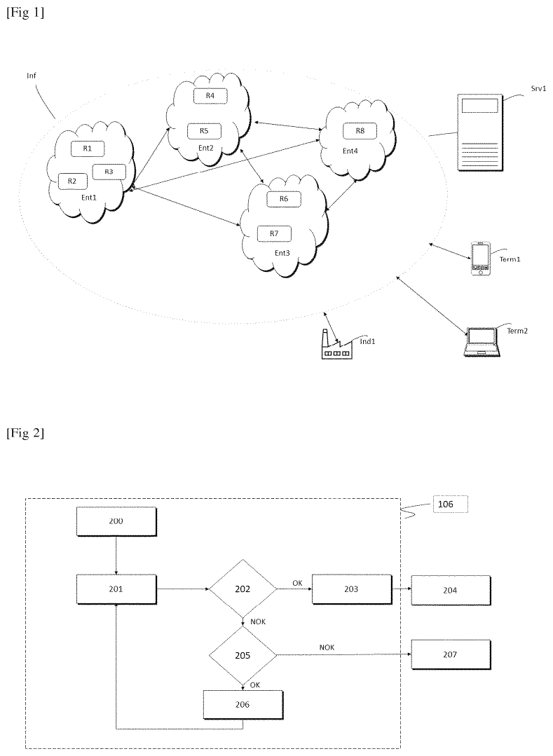

Reference is made first to FIG. 1, which shows a data infrastructure of data made available by a set of parties according to one aspect of the invention. The data infrastructure Inf is developed in a communication network that is not shown in FIG. 1. The data infrastructure Inf may equally be called a virtual data space. This infrastructure comprises resources R1, R2, . . . , R8 that are made available by entities Ent1, Ent2, Ent3 and Ent4. By way of example, the resources R1, R2, . . . , R8 may be storage spaces, for example in centralized or distributed clouds (for example MEC (Mobile Edge Computing) clouds), computing resources for carrying out processing to be applied to certain data, transmission capacities made available by an entity to route data from one resource to another resource or from a transmitter (client, terminal, server) to a resource or a receiver (server, client terminal). A resource, according to another example, may also comprise a datum, for example to enrich a data flow or to associate a datum with a user according to another example. A resource may also comprise a hardware resource and/or a software resource, for example a virtualized function, of an equipment assigned to a data infrastructure, for example for a predefined duration. An entity may be a company, a client, an operator of a communication network, a provider carrying out for example a specific task (security, audit, etc.), a data processing provider, a content provider or else a data storage space manager.

A communication network may comprise a plurality of data infrastructures developed from separate resources for each data infrastructure, or else from resources shared between multiple data infrastructures. An entity may contribute to one or more data infrastructures and may make available one or more resources, which themselves contribute to a single data infrastructure or to multiple infrastructures. Thus, in FIG. 1, the entity Ent1 makes available the resources R1, R2, R3, the entity Ent2 makes available the resources R4 and R5, the entity Ent3 makes available the resources R6 and R7 and the entity Ent4 makes available the resource R8 to the data infrastructure. The entities may furthermore make available, to the infrastructure Inf, one or more resources for a limited time that may or may not correspond to the time during which the data infrastructure Inf is instantiated. The data infrastructure Inf may also be modified or updated by adding, removing or modifying a resource R1, R2, . . . , R8 of the infrastructure, for example to meet a requirement of a user or of a service or to satisfy a recommendation, for example a regulatory recommendation.

In FIG. 1, the data infrastructure Inf is deployed for a time t so as to allow the terminal Term1 (which may be mobile) to upload data to the server Srv1, and to allow the terminal Term2 (which may be fixed) to obtain data from the server Srv1 and to route data to the company Ind1. These various services for the terminals Term1 and Term2, for the server Srv1 and for the company Ind1 do not necessarily require all of the resources R1, R2, . . . , R8 of the data infrastructure Inf. A resource R1, R2, . . . , R8 of the data infrastructure Inf may thus be made available specifically for the company Ind1. For example, the resource R3 of the entity Ent1 may be made available to the data infrastructure for the need of a data service of the company Ind1. According to one example, a data infrastructure is associated with one or more services and a data infrastructure may comprise one or more data infrastructures. For example, in FIG. 1, the data infrastructure Inf may comprise three data sub-infrastructures Inf2, Inf3, Inf4 that are not shown in FIG. 1, each of these data infrastructures Inf2, Inf3, Inf4 being respectively associated with a service of the company Ind1, of the terminal Term1 and of the terminal Term2. It is thus possible to dynamically develop a data infrastructure associated with one or more services within a communication network. The data infrastructure Inf is developed from virtual resources or physical resources. Virtual resources are likely to be more suitable for a high degree of dynamism of the data infrastructures with regard to implementing them, removing them or even updating them, while physical resources will likely be more suitable for data infrastructures that are more sustainable over time.

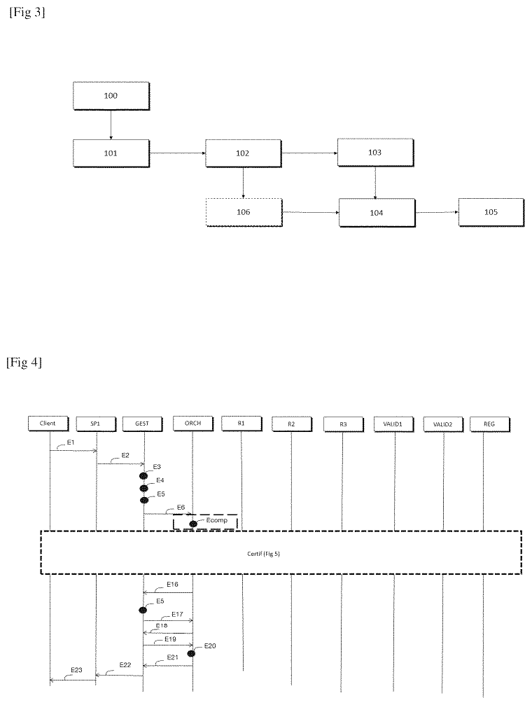

Reference is made next to FIG. 2, which shows a method for certifying a resource in a data infrastructure according to one embodiment of the invention. Certifying a resource intended to be made available to a data infrastructure makes it possible to be able to ensure that the resource corresponds to the constraints of the data infrastructure and is also suitable for the service instantiated in the data infrastructure.

In a step 200, a service management device indicates, to the various participants possibly able to contribute to a data infrastructure, the addresses of the evaluation entities of the communication network, on which the data infrastructure is developed, responsible for certifying resources prior to deployment or activation thereof in a data infrastructure. In the knowledge that an evaluation entity is able to certify only certain parameters of the resource, it is advantageous to provide a plurality of evaluation entities so that each parameter of the resource to be integrated into a data infrastructure is able to be certified globally by the certification of the respective evaluation entities. According to one example, one evaluation entity may certify a parameter relating to the identifier of the resource to be deployed, while another evaluation entity may certify a location parameter, and another evaluation entity may certify a parameter relating to the storage or routing capacity of the resource. The parameters of a resource to be certified are inherent to the resource depending on the role of the resource in the data infrastructure (storage, routing, computing, identity of the owner/manager of the resource, etc.) or else more generic, for example for the identification parameters, location parameters for example. One and the same evaluation entity may also certify more than one parameter of a resource. The service management device may advantageously indicate the parameters that the evaluation entity is able to certify in addition to the address of the evaluation entity. The address of the entity may be an address in the communication network, such as for example an IP address, or else an identifier, for example a DNS identifier. The entity that receives an address from a virtualization entity is for example a function orchestrator. The orchestrators of the entities able to contribute to a data infrastructure thus receive the addresses or identifiers of the evaluation entities able to certify the resources prior to use thereof in a data infrastructure.

The orchestrators of the entities transmit the received information to the various resources so that these are able to be certified prior to being made available in a data infrastructure. This certification may be carried out a priori, for example on the basis of generic services whose characteristics are known a priori, or else following the request to implement a service in a data infrastructure.

In a step 201, a resource transmits, to an evaluation entity, a request to certify a parameter of the resource contributing to the service to be instantiated. This transmission takes place following the reception of a request for a service to be instantiated or else in anticipation of a service to be instantiated. The resource will thus be able to be deployed more quickly since it will have been certified. The resource may send a request to all of the validation entities for which it has received an address or else to one validation entity in particular depending on the parameter to be certified, the information about the validation entity that is valid depending on the parameter being able to be obtained from the orchestrator or else by using a table associating a validation entity and a parameter of a resource. The resource describes the parameters of the resource in a self-describing scheme (SSD) and submits this SSD for certification to one or more evaluation entities depending on the number of parameters to be certified. In the event of a certification following a service implementation request, the self-describing scheme comprises in particular parameters that contribute to the implementation of the service to be implemented by way of the data infrastructure to be developed based on the resources to be certified.

In a step 202, the evaluation entity compares the received self-describing scheme comprising one or more parameters with at least one value required to implement the service in the data infrastructure. For example, if a parameter relates to location, the evaluation entity will compare the location parameter with an expected location area for the resource. If a routing capacity is involved, the evaluation entity will compare the routing capacity made available by the resource with an expected bandwidth value for the service. If a parameter related to storage capacity or computing capacity is involved, the evaluation entity compares the received parameter or the value of the parameter with a capacity required for the service. The evaluation entity may certify the various parameters for which it is responsible globally, based on the comparison of all of the evaluated parameters, or else it may certify each of the parameters individually. The expected values for a service may be discrete values or else intervals or even values with percentages above or below which the parameter is considered to be valid and therefore positive with regard to the certification of the resource for this parameter.

In a step 203, if the result of the comparison is positive, that is to say the parameter or parameters compared by the evaluation entity correspond to the expected values, the evaluation entity transmits a certification datum to the resource attesting that the evaluated parameters of the self-describing scheme are valid for the service required in the data infrastructure. If multiple evaluation entities evaluate various parameters of the resource, this resource will be certified if the various evaluation entities indicate that the various parameters evaluated by the various evaluation entities correspond to the values respectively expected by the various evaluation entities.

The proof of certification of one or more parameters of a resource by an evaluation entity may comprise a private key of the evaluation entity or a signature of the one or more evaluated parameters by a private key, attesting to certification by an evaluation entity. According to one example, all of the private keys or certificates of the evaluation entities that respectively evaluated the various parameters of the resource are used to prove certification of the resource for all of the evaluated parameters.

In a step 204, if the resource is effectively certified, the resource or else a resource manager that obtained the information regarding certification of the resource transmits, to the service management device and/or to a resource register, information attesting to the compliance of the resource for the service to be implemented in the data infrastructure. This certification is valid for one service in the data infrastructure and cannot be used for another service unless this other service has characteristics identical to the first service, this potentially authorizing reuse of the certification information. This compliance information may, according to one example, be transmitted to the service management device. This device is thus able to associate a service with certified resources and is also able to guarantee that the resources actually used to update a data infrastructure to ensure the provision of a service have indeed been certified beforehand and comprise parameters compatible with the service to be deployed. According to another example, the information attesting to the compliance of the resource may be transmitted to a resource manager of the data infrastructure that is called upon by the service management device or by another entity, for example in the event of the resources being audited.

If, in step 202, the comparison of a parameter with an expected value is not positive and the parameter therefore does not correspond to an expected value for certifying the parameter for the service to be implemented, the reason why the parameter does not correspond to an expected value and the impact on the service are evaluated. Thus, in step 205, the cause of the failure of the certification by the evaluation entity is identified in particular by virtue of the information about the failure transmitted by the evaluation entity to the resource. Said resource is thus able to evaluate which parameter of the resource in the self-describing scheme did not allow the resource to be certified. If the parameter cannot be modified, for example if it is a parameter inherent to the resource such as a parameter regarding the location of the resource, or a maximum capacity of the resource in terms of storage, computing or routing, for example, the resource is considered to be non-compliant for the service to be deployed and information regarding non-compliance of the resource is transmitted, in a step 207, to the service management device and/or to a resource register, not authorizing the use of this resource to update the data infrastructure to implement the required service.

If a parameter that is able to be modified in the self-describing scheme is involved, for example a number of interfaces available for the service to be instantiated or a bandwidth value that is able to be modified for the resource, a new self-describing scheme comprising one or more modified parameters for the same resource may be determined in a step 206 and again submitted to the evaluation entity for certification in a step 201 so that the modified parameters are able to be compared with expected values in order to integrate the resource into the data infrastructure with a view to instantiating the service. Multiple modifications of one or more parameters and therefore multiple parameter evaluations by an evaluation entity are conceivable before compliance or non-compliance information (respective steps 204 and 207) is transmitted.

In the event of non-compliance or else if one or more parameters do not allow the resource to be certified by the evaluation entity, another resource of one and the same entity or of another entity, called upon in step 200, contributing to the data infrastructure may be evaluated by the evaluation entity, so as to be able to determine and certify an alternative resource for updating the data infrastructure for the service to be instantiated.

Reference is made next to FIG. 3, which shows a method for dynamically developing a data infrastructure, according to another embodiment of the invention.

This method for dynamically developing a data infrastructure makes it possible to construct or update a data infrastructure so as to allow a data service to be implemented. Application services involving a client terminal and/or a data server and/or IoT (Internet of Things) applications require different resources and resource parameters adapted to the various services. The instantiation of a new service therefore requires updating of a data infrastructure or even implementation of a new data infrastructure in order to guarantee appropriate routing of the data of the service in the communication network in which the data infrastructure, also called virtual data space, is developed.

In a step 100, a service management device receives a request to instantiate a service. The request comprises a parameter relating to a user of the service, corresponding for example to information about the user's consent to share or use data specific to the user, and the request furthermore comprises a parameter relating to the geographical area in which said service is to be deployed. According to one example, the geographical area corresponds to a GPS datum or to geographical coordinates. This request is for example transmitted by a service management device responsible for providing services to customers, a telecommunications operator, or a business services operator.

The request may furthermore comprise characteristics intrinsic to the service to be implemented, such as characteristics regarding quality of service, security of the service, or the type of service management device, such as the country to which the device belongs, or confidentiality. The request may furthermore comprise information about the deadline to be complied with to instantiate the service, that is to say the deadline within which the service must be instantiated.

The service management device determines, based on the received request, one or more entities able to contribute to the implementation of the service via the updating of the data infrastructure. Thus, in step 101, the management device identifies orchestrators of entities able to provide resources that contribute to the data infrastructure, to be modified to satisfy the provision of the required service. The management device thus uses the parameter relating to the user and the parameter relating to the geographical area, these parameters being able to limit to entities that guarantee compliance with the constraints associated with the user and/or the constraints of deploying resources in a given geographical area. Thus, if for example the present geographical area is France, the management device will call upon entities having resources in France. The management device thus transmits, in this step 101, a request for resources, determined to satisfy the required service, to one (or more) orchestrators of the previously determined entities. The management device may thus use the various parameters associated with the service (security, quality of service, confidentiality, etc.) to determine the resources required for a given service. According to another example, the management device consults or calls upon another device of the communication network to obtain a list of resources corresponding to the service to be implemented. This correspondence makes it possible to determine the resources to be added or modified in a data infrastructure to guarantee the provision of the service to be instantiated. If resources required for the service, corresponding to the parameters of the request, are already present in the data space, then the management device may refrain from calling upon an entity to add such a resource to the virtual data space. Orchestrators to be called upon may be identified after the service management device has determined the resources needed to implement the required service. The orchestrators able to provide the necessary resources will then be selected on the basis of the resources to be deployed to instantiate the requested service.

In a step 102, the orchestrator called upon in step 101 identifies resources specific to its entity that are able to contribute to the service and that are therefore potentially to be added to the data infrastructure on the basis of the received parameters and compliance criterion and values relating to the service and to the data infrastructure. Indeed, newly deployed resources have to comply with constraints as received in the deployment request, but also constraints relating to the data infrastructure and theoretical values relating to the service. The orchestrator first determines whether the resource is still present in the communication network by calling upon for example an administration device of the communication network. If the resource is not present, the orchestrator may deploy or request the deployment of a new resource the characteristics of which make it possible to meet the characteristics of the service to be instantiated. If multiple orchestrators of one and the same entity or of multiple entities are called upon, each orchestrator verifies the possible availability of the resources that it manages in the data infrastructure of the communication network. Thus, for a VoD (Video on Demand) service, an orchestrator of a telecommunications operator providing routing resources, an orchestrator of a VoD stream storage entity, an orchestrator of a cache network and a billing management orchestrator could for example be called upon to make their respective resources available. The data infrastructure, which is capable of supporting VoD data streams, will thus be developed by adding the resources of the various entities involved in the provision of the VoD service.

According to a first example, the orchestrator transmits the received information, and in particular the parameters relating to the service to be instantiated, to the various resources so that they are able to be certified prior to being made available in a data infrastructure. The orchestrator furthermore transmits an address of an evaluation entity so that the resource, and more precisely the parameters of the resource to be certified, is certified in step 106, prior to deployment thereof in the communication network with a view to updating the data space. Step 106 corresponds to the certification of a resource as described in FIG. 2 and the corresponding text describing FIG. 2.

If the resource is effectively certified, said resource, in a step 104, transmits a certification datum, such as for example a private key of the resource, attesting that the resource to be deployed in the data space effectively complies with the characteristics of the data space for the service to be instantiated. As indicated in FIG. 2, if the resource is not able to be certified, then non-compliance information is transmitted to the orchestrator, and said orchestrator may call upon another resource belonging to the same entity or to another entity, for example via the orchestrator of the other entity. Upon reception of the certification datum, in step 105, the orchestrator transmits, to the service management device, an agreement message comprising an identification of the resource to be deployed in the data infrastructure, the message comprising, according to one example, an identifier of the resource and the certification datum certifying the resource. When the service management device has obtained the certifications of the various resources required for the service to be instantiated, it may then deploy or transmit information about the resources to a management entity responsible for developing the data infrastructure based on the newly certified resources in order to instantiate the required service. According to one example, these resources may be removed once the service is no longer used or activated so as to reduce the resources contained in a data infrastructure to their strict minimum, thus reducing management costs and energy consumption of the data infrastructure.

According to another option, if for example the required resource has already been certified for an equivalent service, for example in a service deployment that already gave rise to the deployment of the resource in question, but said resource was removed from the data space following the end of execution of the service, the orchestrator or else the resource register may, in a step 103, obtain the certified resource, for example with the certification datum, without it being necessary to certify the resource again. According to one alternative, the resource may be stored in a database accessible to the orchestrator or in the resource register, thus avoiding the need to carry out a new certification. According to one example, the resource register may be collocated with the service management device, allowing optimized management of the resources assigned to a service in a data infrastructure.

Since a resource is selected on the basis of a service to be implemented in the data infrastructure, reusing a certified resource may be effective if the new service to be instantiated is identical to or comprises the same parameters or a subset of the parameters as the service for which the resource was previously certified.

The certification may have a limited duration and, if the deadline has expired, the orchestrator will have to certify the resource in accordance with step 106.

According to another option, the service to be instantiated does not require certified resources and the orchestrator, in an alternative step to step 106 or step 103 not shown in FIG. 3, obtains resources that are not certified, and therefore without a certification datum certifying the resource, the obtainment possibly comprising calling upon other orchestrators of entities contributing to the data infrastructure.

Reference is made next to FIG. 4, which shows a method for dynamically developing a data infrastructure based on certified resources, according to another embodiment of the invention.

In a step E1, a client requests a service or access to a new service from a service provider SP1. According to one example, this client, which may be a home or business client, transmits, in their request, a (client) user parameter relating to a quality of service required for this service, this quality possibly being formulated for example in business terms with a term from among the following terms: standard, silver, gold, these terms being ranked in order of expected level of quality from least demanding (standard) to most demanding (gold). The client also inserts one or more parameters relating to the user, such as for example a parameter indicating that the user or the client consents to the analysis of data or collection of data concerning them in relation to the requested service to be instantiated in a virtual data network. According to one example, the client also indicates the geographical area in which the service is to be instantiated. This information is optional because, in one alternative, the service provider may determine the geographical area based on the location of the client transmitting the request.

In a step E2, the service provider SP1, following reception of the request, transmits, to a service management device GEST, a request to instantiate the service requested by the client in a data infrastructure, the request comprising the parameters relating to the user of the service and a parameter relating to the geographical area in which the service is to be instantiated. This request may be transmitted to the service provider via an OSS (Operation Support System) entity. The parameter relating to the geographical area may comprise a GPS datum or an indication of an area in the data infrastructure, for example in relation to the location of an equipment of the data infrastructure.

In a step E3, the service management device GEST determines the resources required to implement the requested service, in accordance with the parameters contained in the received request. According to one example, for a service for accessing a videophone service via access to a mobile network, the device determines access resources in a 5G mobile network, a resource corresponding to a server for connecting a videophone service, a resource corresponding to transmission capacities between the client and the mobile network and between the mobile network and the server. According to one alternative, a resource may also comprise a datum used to implement the service, such as a quality of service or billing datum, a capacity to route a datum of the service such as access to a fixed or mobile network or a routing link between two devices, an identifier of a data center such as an identifier of a server in a cloud environment, a software function able to process a datum of the service such as an application or a computer program. Furthermore, if the client has given consent to collect data relating to the service, the determined resources must enable this collection. According to another example, the service management device does not determine the resources itself, and calls upon the various orchestrators so that they determine the resources needed to deploy the service, information about the service being transmitted by the service management device in a step that is described below. Step E3 is therefore an optional step in the implementation of the method for dynamically developing the data infrastructure.

In a step E4, the service management device GEST determines whether such resources compatible with the service to be instantiated are present in a database of certified resources. It is considered that the transmission capacities are present in the database and may therefore be used without having to call upon entities pooling resources in the data infrastructure.

It is therefore apparent that resources must be deployed to update the data infrastructure in order to instantiate the service requested by the client in step E1. According to one example, the service management device may call upon another resource management device, managing for example virtualized resources, to determine the resources required for the service to be instantiated. In a step E5, the service management device GEST identifies one or more entities able to make the missing certified resources available in order to implement the service and, based on these entities, in this same step E5, identifies the orchestrators of these entities to be called upon to deploy the certified resources. The information about the entities, the resources managed by these entities and the orchestrators associated with these entities is advantageously contained in a database maintained by the service management device GEST or by an entity that the service management device is able to reach.

In a step E6, the service management device calls upon an orchestrator ORCH so that certified resources associated with the service managed by the orchestrator are made available. The orchestrator may be selected on the basis of the resources identified in step E3 or else by default, and in this case, the orchestrator determines whether resources that it manages are able to contribute to the service identified in the message from step E6. According to the example under consideration in this embodiment, access resources in a 5G mobile network and a server for connecting a videophone service are to be instantiated in the data infrastructure, and orchestrators able to provide these resources are called upon in step E6. FIG. 4 comprises only one orchestrator to make the figure easier to read, but a plurality of orchestrators may be called upon in step E6. The request to deploy a resource in the data infrastructure, transmitted in step E6, comprises the parameters obtained in step E2, namely the parameter relating to a user or client of the service and a parameter relating to the geographical area in which the service is to be instantiated. According to one example, the deployment request may advantageously comprise a deadline to be complied with for making the resource available and, according to another example, the request may also comprise an indication as to whether or not it is necessary for the resource that is made available to be certified. According to one alternative, if the resource is to be certified, an identifier or an address of a validation entity able to certify the one or more resources may be attached to the deployment request. The deployment request furthermore comprises a criterion regarding compliance of the resource to be deployed with the data infrastructure. This compliance criterion may in particular comprise an indication about the need to deploy a certified resource, and/or an indication about a quality of service or security parameter specific to the data infrastructure in which the resource is to be instantiated. The resource to be deployed must therefore guarantee that the security and/or quality of service and/or reliability level of the data infrastructure is guaranteed after the resource has been deployed.

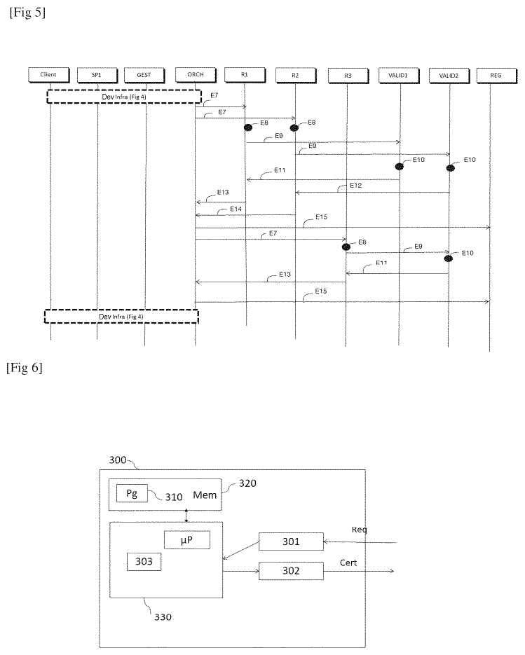

The following steps for deploying certified resources in a data infrastructure for the provision of a service are described in FIG. 5. In a step E7, the orchestrator ORCH, having determined the resources R1 and R2 that may potentially be compatible with the required service and the data infrastructure, transmits, to these resources R1 and R2, a request to create a description of these resources, this creation request comprising the parameters relating to the service, as present in the message from step E2, and the compliance criterion present in the deployment request received in step E6. According to this example, the resource R1 corresponds to a resource for accessing a 5G mobile network and the resource R2 corresponds to a connection server for a videophone service. If for example the compliance criterion comprises a need to certify the resource, the request to create a description of the required resource may comprise an address or an identifier of a validation entity for validating the resource. This address or this identifier may, according to another alternative, be contained in a database accessible to the resource if certification is required. It is considered in this example that the resource, and more precisely its description, must be certified by a validation entity and the request to create a resource description comprises an address of a validation entity, in this example specific to each resource. Thus, the address of the entity VALID1 is transmitted to the resource R1, and the address of the entity VALID2 is transmitted to the resource R2. Depending on the type of resource, the validation entity VALID1 (or VALID2) may be an entity of a network of a fixed or mobile operator, such as the Network Slice Selection Function entity for selecting a network slice of the infrastructure, a Network Data Analytics Function entity for analyzing network data of the infrastructure, a Network Exposure Function entity for exposing functions of the infrastructure, or else a gateway, for example a UPF gateway, of a mobile network.

In a step E8, corresponding to the start of a resource certification phase CERTIF, the resource R1 (or R2) determines at least one parameter corresponding to a service prescription, in accordance with the obtained parameters of the service and of the compliance criterion, also in step E7.

In a step E9, the resource R1 (or R2) transmits, to the validation entity VALID1, a request to certify the resource R1, comprising a description of the resource R1. This description comprises the one or more parameters determined in step E8 and therefore corresponds to the service to be instantiated and to the data infrastructure. According to one example, the description of the resource may thus comprise one or more of the following parameters and possibly a generic parameter in addition to all of the parameters below (network location such as an IP address, a cell or fixed termination identifier, a geographical location (GPS, zip code)):
a parameter relating to the location of the resource R1 (or R2),
a parameter relating to the data processing capacities of the resource R1 (or R2),
a parameter relating to the transfer capacities of a link from the resource R1 (or R2) to the data infrastructure,
a parameter relating to a protocol and/or a protocol version supported by the resource R1 (or R2),
a parameter regarding compatibility of the resource with another resource, for example the resource R2 (or R1), of the infrastructure,
a security parameter supported by the resource R1 (or R2),
an identifier or a description of a software function, such as a container and/or a virtualized network function implemented in the resource R1 (or R2).

The certification request may furthermore comprise an identifier of the service and an identifier of the data infrastructure if the validation entity VALID1 (or VALID2) is not an entity specific to the service and/or to the data infrastructure.

According to an optional step that is not shown in FIG. 4, the resource R1 (or R2) has the parameter description checked by the orchestrator ORCH before having the description certified by the validation entity, and therefore before step E9, so as to ensure that the determined parameters indeed correspond to the service to be instantiated in the data infrastructure.

In a step E10, the validation entity VALID1 (or VALID2) compares the parameters present in the description in the certification request received from the resource R1 (or R2) with at least one value required to implement the service in the data infrastructure. Depending on the parameters, a margin of error or acceptability is possible for the parameters.

In the favorable case where the parameters of the resource description correspond to the theoretical values used for the comparison in step E10, then the resource may be certified by the validation entity VALID1 (or VALID2). According to one example, it is considered that the resource R1 corresponding to a resource for accessing a mobile network has been validated by the validation entity VALID1 corresponding, in this example, to a UPF (User Plane Function) mobile network gateway. In step E11, the entity VALID1 transmits, to the resource R1, a certification datum certifying the resource in the data infrastructure for the service to be instantiated. In this alternative, this certification datum comprises a private key of the entity VALID1 attesting to the certification of the parameters of the resource R1 by the entity VALID1. According to another example, this certification datum corresponds to the at least one parameter signed by a certificate using a private key of the validation entity VALID1.

According to this example, it is considered that the resource R2 is not certified by the entity VALID2 because one or more parameters of the description do not correspond to the expected values for the service to be instantiated in the data infrastructure. In a step E12, the entity VALID2 transmits a message to the resource R2 indicating that the resource R2 is not certified, and possibly the criterion and/or the non-compliance criterion that led to the non-certification. According to one alternative, the resource R2 may consider that it is not certified if it does not receive a response to its certification request.

In respective steps E13 and E14, the resources R1 and R2 inform the orchestrator ORCH of their certification or their non-certification. The resource R1 thus transmits a message comprising the certification datum received from the validation entity VALID1. The resource R2 transmits, to the orchestrator ORCH, a message indicating that it has not been certified by the validation entity VALID2 or that it is not compliant. Upon reception of these messages, the orchestrator ORCH registers the resource R1 in a resource register REG the resources of which are managed by the orchestrator. The orchestrator ORCH furthermore registers the non-certification of the resource R2 and the criterion and/or the non-compliance criterion that led to the non-certification so as not to call upon this resource if the criterion that failed is required for a new service to be instantiated. According to one alternative, the resources R1 and R2 may themselves transmit the certification or non-certification information received from the validation entities VALID1 and VALID2. The orchestrator ORCH may call upon the register REG if needed in the future. This resource register REG is also identified as a resource compliance entity of the data infrastructure.

According to one example, in a step E7, the orchestrator ORCH transmits a certification request to a resource R3. This request is in accordance with the request described in step E7, and the resource R3 has been identified in a manner corresponding to what has been described for the resources R1 and R2. Like the resource R2, the resource R3 corresponds to a connection server for the videophone service according to this example. The resource R3 that has been newly called upon carries out steps E8 and E9 in accordance with the same steps described above, and the validation entity VALID2 carries out the comparison in step E10 described above. According to one alternative, the validation entity responsible for certifying the resource R3 may be different from the validation entity VALID2.

The validation entity VALID2, having compared the transmitted parameters of the resource R3 with the parameters required for the service and having determined, through this comparison, that the resource R3 is compliant with the service and the data infrastructure, in step E13, transmits a certification datum certifying the resource R3 to the orchestrator ORCH. In a step E15, the resource compliance entity REG then receives a message from the orchestration entity ORCH or from the resource R3 attesting that the resource R3 is compliant for the videophone service in the data infrastructure.

According to one example, the certification data comprise durations for which the certification is valid. These durations allow the orchestrator ORCH and possibly the compliance entity REG to determine whether a certification of a resource is still valid and whether this resource may be used for a new equivalent service in the data infrastructure.

Instead of steps E7 to E15 or prior to these steps, the orchestration entity ORCH may call upon the compliance entity REG to obtain certified resources for a service by specifying the parameters of the service so that the compliance entity REG is able to identify the appropriate resources. The entity ORCH thus determines resources able to be deployed, these resources complying with the parameters received in the deployment request, but also parameters intrinsic to the data infrastructure and values of the service. The entity ORCH may for example compare the received parameters and the compliance criterion received in step E6 with what are referred to as theoretical required values for instantiating the service in the data infrastructure autonomously or via resource validation entities. These validation entities perform this comparison for the benefit of the entity ORCH if no resource corresponding to the parameters and to the compliance criterion is present in the register REG or is no longer valid. Steps E7 to E15 are then carried out if no resource of the compliance entity REG is suitable or if one of the required resources is not present in the compliance entity REG or is not suitable for the service to be instantiated. The comparison of the received parameters and of the compliance criterion with values required for the service to be instantiated is therefore carried out autonomously by the entity ORCH or via the entities VALID1 and VALID2 if no resource enabling the required values to be complied with is present in the register REG. Steps E7 to E15 may therefore, according to one example, correspond to a single determination step Ecomp performed by the entity ORCH.

The rest of the updating of the data infrastructure is described in FIG. 4. In a step E16, the orchestration entity ORCH transmits, to the service management device GEST, an agreement message comprising the identifier of the resource able to be deployed in the data infrastructure following steps E7 to E15 or, alternatively, the step Ecomp. According to the embodiment described in FIG. 4 and FIG. 5, the orchestration entity ORCH has aggregated the certification data received from the called-upon resources that transmitted their certification datum, namely R1 and R3. The orchestration entity ORCH thus transmits the identifiers of the resources R1 and R3 corresponding to resources that make it possible to be able to instantiate the videophone service in the data infrastructure. According to this embodiment, the resources are certified in accordance with the steps described in FIG. 5. According to another example, the updating of the data infrastructure does not require certified resources, and the orchestrator ORCH, in step E16, transmits resource identifiers by exploiting for example information about these resources in a database, these resources having to correspond to the parameters of the instantiation request and to the criterion regarding compliance of the resources with the data infrastructure, which, according to this example, does not correspond to certified resources.

According to one alternative, the orchestrator ORCH transmits, to the service management device GEST, one or more resources from among the resources required by the service management device GEST in step E6. If at least one resource is missing for implementing the service or one of the transmitted resources is no longer available following information transmitted by the orchestration entity ORCH or following testing of the resource by the service management device GEST, the entity GEST, in a step E5, determines a new orchestrator, managed by the same entity as the preceding orchestrator ORCH or by a separate entity, able to provide information about a resource to be deployed in the data infrastructure. According to one example, the service management device GEST, in a step E17, calls upon an orchestrator of an entity different from the first entity called upon in step E6 or else the same orchestrator ORCH. Orchestrators may be called upon multiple times before the service management device GEST obtains the necessary resources, and possibly the certification data for these resources, to update the data infrastructure. According to one alternative, when multiple deployment requests are transmitted, the service management device GEST initiates a counter when the first request is sent and increments this counter when a new request is sent. If no required resource is received when the counter reaches a maximum value, a notification message indicating the inability to deploy one or more resources is transmitted in step E18, indicating the one or more missing resources. If a counter is initialized for a particular entity or even for an orchestrator of the particular entity, the service management device GEST may call upon another entity or another orchestrator of the same entity when the counter has reached a value predefined by the service management device GEST. In the absence of a counter, this notification message is transmitted when the service management device GEST does not receive all of the required resources from one or more orchestrators following a first request. If all of the resources have been able to be identified by one or more orchestrators, the service management device GEST transmits, to the service provider, a notification message indicating that all of the resources have been identified, this message, according to one example, comprising the certification data.

In a step E19, the service management device GEST acknowledges the received notification message and, if all of the resources have been determined, asks the orchestrator ORCH to effectively deploy the resources, possibly with an effective deployment time, so that the service at the origin of the updating of the data infrastructure is able to be instantiated.

In step E20, the orchestrator ORCH deploys the required resources, for example by calling upon a configuration device, not shown in FIG. 4, in accordance with the parameters received in step E6.

Once the deployment takes effect, the orchestration entity ORCH informs the service management device GEST of this in a step E21, which may, in turn, inform the service provider SP1 of this in a step E22.

The data infrastructure has thus been updated with the resources R1 and R3 and the service requested by the CLIENT is able to be satisfied with these new resources in the data infrastructure, the CLIENT being informed by the service provider SP1 of the activation of this service in a step E23.

It should be noted that the steps of FIG. 5 may be implemented in the absence of updating of the data infrastructure, for example so that an orchestrator is able to have an up-to-date list of certified resources corresponding to a service in a data infrastructure.

Reference is made next to FIG. 6, which shows a device 300 for certifying a resource contributing to a communication service able to be instantiated in a data infrastructure according to another embodiment.

Such a certification device may be implemented in a Network Slice Selection Function entity for selecting a network slice of the infrastructure, a Network Data Analytics Function entity for analyzing network data of the infrastructure, a Network Exposure Function entity for exposing functions of the infrastructure, a management or control entity of the infrastructure, or an administration entity of the infrastructure.

For example, the certification device 300 comprises a processing unit 330, equipped for example with a microprocessor μP and controlled by a computer program 310, stored in a memory 320 and implementing the certification method according to the invention. On initialization, the code instructions of the computer program 310 are for example loaded into a RAM memory, before being executed by the processor of the processing unit 330.

Such a certification device 300 comprises:
a receiver 301, able to receive, from the resource, a request Req to certify the at least one parameter of the resource contributing to the service to be instantiated,
a comparator 303, able to compare the at least one parameter contained in the received request with at least one value required to implement the service in the data infrastructure,
a transmitter 302, able to transmit, to the resource, a certification datum Cert certifying the resource in the data infrastructure for the service to be instantiated if the at least one parameter is equivalent to the required value.

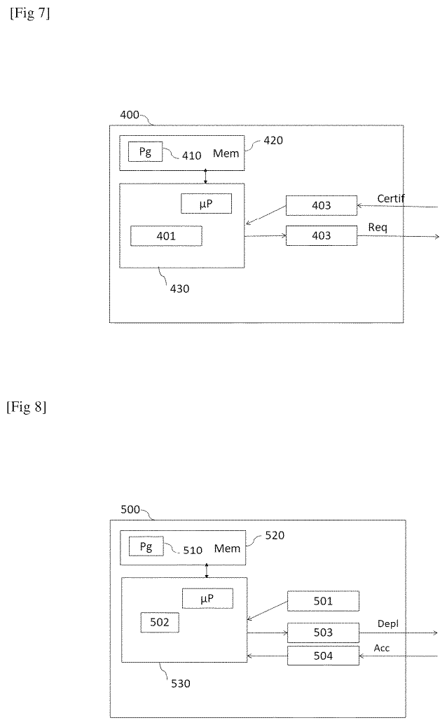

Reference is made next to FIG. 7, which shows a device 400 for validating at least one parameter of a resource contributing to a communication service to be instantiated in a data architecture according to another embodiment.

Such a validation device may be implemented in a resource, this resource possibly being a software function, a physical equipment, a storage space or a manager of this space, a routing link or a manager of this link, a processing and/or computing capacity or a manager of this capacity.

For example, the validation device 400 comprises a processing unit 430, equipped for example with a microprocessor μP and controlled by a computer program 410, stored in a memory 420 and implementing the certification method according to the invention. On initialization, the code instructions of the computer program 410 are for example loaded into a RAM memory, before being executed by the processor of the processing unit 430.

Such a validation device 400 comprises:
a determination module 401, able to determine at least one parameter corresponding to a service prescription obtained from a service management entity of the infrastructure,
a transmitter 402, able to transmit, to the validation entity, a request Req to certify the at least one parameter of the resource,
a receiver 403, able to receive, from the evaluation entity, a certification datum Certif certifying the resource in the data infrastructure for the service to be instantiated if the at least one parameter is equivalent to a value required to implement the service in the data infrastructure.

Reference is made to FIG. 8, which shows a device for dynamically developing a data infrastructure in a communication network according to another embodiment.

Such a dynamic development device 500 may be implemented in a service management device such as a service administration platform of a communication network or a server for controlling services for the attention of a client of the communication network.

For example, the dynamic development device 500 comprises a processing unit 530, equipped for example with a microprocessor μP and controlled by a computer program 510, stored in a memory 520 and implementing the certification method according to the invention. On initialization, the code instructions of the computer program 510 are for example loaded into a RAM memory, before being executed by the processor of the processing unit 530.

Such a dynamic development device 500 comprises:
an obtaining module 501, able to obtain a request to instantiate said service, said request comprising a parameter relating to a user of the service and a parameter relating to the geographical area in which said service is to be instantiated,
a determination module 502, able to determine an entity of the plurality, able to contribute to the implementation of said service, on the basis of the parameters obtained in the instantiation request,
a transmitter 503, able to send, to a resource orchestration device of said determined entity, a first request Depl to deploy a resource in the data infrastructure, said first request comprising the obtained parameters and a criterion regarding compliance of the resource with the data infrastructure,
a receiver 504, able to receive, from the orchestration device of said entity of the plurality, an agreement message Acc comprising an identification of the resource to be deployed in the data infrastructure.

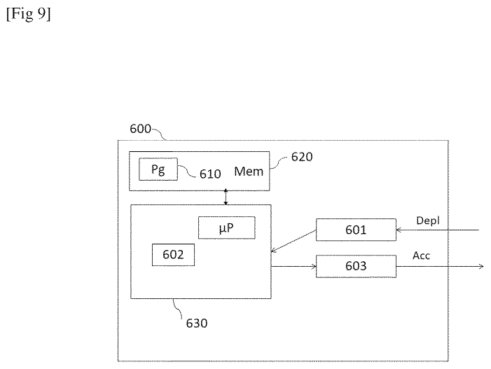

Reference is made next to FIG. 9, which shows a device 600 for making available a resource in a data infrastructure of a communication network for instantiating a service according to another embodiment.

Such an availability-making device 600 may be implemented in a resource orchestration device, also called an orchestrator in virtualized network architectures. For example, the availability-making device 600 comprises a processing unit 630, equipped for example with a microprocessor μP and controlled by a computer program 610, stored in a memory 620 and implementing the certification method according to the invention. On initialization, the code instructions of the computer program 610 are for example loaded into a RAM memory, before being executed by the processor of the processing unit 630.

Such a dynamic development device 600 comprises:
a receiver 601, able to receive, from a service management device, a request Depl to deploy a resource in the data infrastructure, said request comprising a parameter relating to the user of the service and a parameter relating to the geographical area in which said service is to be deployed and furthermore comprising a criterion regarding compliance of the resource with the data infrastructure,
a determination module 602, able to determine the resource on the basis of the received parameters and compliance criterion and values relating to the service and to the data infrastructure,
a transmitter 603, able to transmit, to the service management device, an agreement message Acc comprising an identification of the resource to be deployed in the data infrastructure.

1. A certification method for certifying a resource contributing to a communication service able to be instantiated in a data infrastructure, the method being implemented in a validation entity device deployed in the infrastructure, said validation entity device being associated with at least one parameter of the resource, the method comprising:
receiving, from the resource, a request to certify the at least one parameter of the resource contributing to the service to be instantiated;
comparing the at least one parameter contained in the received request with at least one value required to implement the service in the data infrastructure; and
transmitting, to the resource, a certification datum certifying the resource in the data infrastructure for the service to be instantiated if the at least one parameter corresponds to the value required to implement the service.

2. The certification method as claimed in claim 1, wherein the certification datum corresponds to the at least one parameter signed by a certificate using a private encryption key of the validation entity device or to a private encryption key of the validation entity device.

3. The certification method as claimed in claim 1, wherein the at least one parameter comprises one or more of the following parameters:
a parameter relating to a location of the resource,
a parameter relating to data processing capacities of the resource,
a parameter relating to transfer capacities of a link from the resource to the data infrastructure,
a parameter relating to a protocol and/or a protocol version supported by the resource,
a parameter regarding compatibility of the resource with another resource of the infrastructure,
a security parameter supported by the resource,
a parameter relating to a software function of the resource.

4. The certification method as claimed in claim 1, wherein the certification datum furthermore comprises a duration of validity of the certification of the resource.

5. The certification method as claimed in claim 1, wherein the validation entity device is at least one entity from among the following entities:
a network slice selection entity of the infrastructure,
a network data analysis entity of the infrastructure,
a function exposure entity of the infrastructure,
a management or control entity of the infrastructure,
an administration entity of the infrastructure.

6. A validation method for validating at least one parameter of a resource contributing to a communication service to be instantiated in a data architecture, the method being implemented in the resource, able to communicate with a validation entity, the method comprising:
determining at least one parameter corresponding to a service prescription obtained from a service management entity of the infrastructure;
transmitting, to the validation entity, a request to certify the at least one parameter of the resource; and
receiving, from the validation entity, a certification datum certifying the resource in the data infrastructure for the service to be instantiated if the at least one parameter is equivalent to a value required to implement the service in the data infrastructure.

7. The validation method as claimed in claim 6, furthermore comprising transmitting, to a resource compliance entity of the infrastructure, a message validating the resource comprising the received certification datum.

8. The validation method as claimed in claim 6, furthermore comprising, prior to the transmitting, obtaining an identifier of the validation entity associated with the at least one parameter to be validated.

9. The validation method as claimed in claim 6, furthermore comprising aggregating the certification data received from a plurality of validation entities when at least two validation entities are called upon to validate at least two parameters corresponding to the service prescription.

10. A device for certifying a resource contributing to a communication service able to be instantiated in a data infrastructure, said device being associated with at least one parameter of the resource and implemented in the infrastructure, said device comprising:
a receiver, to receive, from the resource, a request to certify the at least one parameter of the resource contributing to the service to be instantiated;
at least one processor;
at least one non-transitory computer readable medium comprising instructions stored thereon which when executed by the at least one processor configure the device to compare the at least one parameter contained in the received request with at least one value required to implement the service in the data infrastructure; and
a transmitter to transmit, to the resource, a certification datum certifying the resource in the data infrastructure for the service to be instantiated if in response to the at least one parameter corresponding to the value required to implement the service.

11. A device for validating at least one parameter of a resource contributing to a communication service to be instantiated in a data infrastructure, said device being able to communicate with an evaluation entity and comprising:
at least one processor;
at least one non-transitory computer readable medium comprising instructions stored thereon which when executed by the at least one processor configure the device to determine at least one parameter corresponding to a service prescription obtained from a service management entity of the infrastructure;
a transmitter to transmit, to the validation entity, a request to certify the at least one parameter of the resource; and
a receiver to receive, from the evaluation entity, a certification datum certifying the resource in the data infrastructure for the service to be instantiated if the at least one parameter corresponds to a value required to implement the service in the data infrastructure.

12. (canceled)

13. (canceled)

14. (canceled)

15. A non-transitory computer-readable recording medium on which there is recorded a program comprising instructions for implementing the certification method as claimed in claim 1.

16. A non-transitory computer-readable recording medium on which there is recorded a program comprising instructions for implementing the validation method as claimed in claim 6.
